(19) United States
(12) Patent Application Publication
(10) Pub. No.: US 2018/0082196 A1
(43) Pub. Date: Mar. 22, 2018

(54) GENERATION APPARATUS, GENERATION METHOD, AND NON-TRANSITORY COMPUTER READABLE STORAGE MEDIUM

(71) Applicant: YAHOO JAPAN CORPORATION, Tokyo (JP)

(72) Inventors: Ikuo KITAGISHI, Tokyo (JP); Akishi TSUMORI, Tokyo (JP); Tooru UENAGA, Tokyo (JP); Akiomi NISHIDA, Tokyo (JP); Takao KOMIYA, Tokyo (JP)

(73) Assignee: YAHOO JAPAN CORPORATION, Tokyo (JP)

(21) Appl. No.: 15/691,421

(22) Filed: Aug. 30, 2017

(30) Foreign Application Priority Data
Sep. 20, 2016 (JP) 2016-182901

(51) Int. Cl. G06N 5/04; G06N 99/00

(52) U.S. Cl. CPC G06N 5/04; G06N 99/005

(57) ABSTRACT

According to one aspect of an embodiment a generation apparatus includes a selection unit that selects a model to be used for generating a response based on one of conditions input from a user among from a plurality of models for generating responses to inquiries, the models being for generating the responses corresponding to the conditions that are different from one another. The generation apparatus includes a generation unit that generates the response to an inquiry from the user by using the model selected by the selection unit.

### CROSS-REFERENCE TO RELATED APPLICATIONS

The present application claims priority to and incorporates by reference the entire contents of Japanese Patent Application No. 2016-182901 filed in Japan on Sep. 20, 2016.

### BACKGROUND OF THE INVENTION

### 1. Field of the Invention

The embodiment discussed herein is related to a generation apparatus, a generation method, and a computer-readable recording medium.

### 2. Description of the Related Art

Recently, there is proposed a technology of an information process using an artificial-intelligence-related technology such as a nature-language process and deep learning. There is known a technology that, when receiving a nature-language question sentence, extracts a feature amount included in the input question sentence and estimates a response to the question sentence by using this extracted feature amount, for example.
Patent Literature 1: Japanese Patent No. 5591871.

However, in the above conventional technology, accuracy in responses is in some cases worse when conditions to be determination references are different form each other because the conditions to be the determination references are not considered.

For example, in a question related to human relation such as a love advice, a determination reference is changed by attributes of a questioner him/herself and the other person, such as genders and ages, and thus there exists a fear that an incorrect response is output when a response to a question sentence is estimated by using the same determination reference.

### SUMMARY OF THE INVENTION

It is an object of the present invention to at least partially solve the problems in the conventional technology.

According to one aspect of an embodiment a generation apparatus includes a selection unit that selects a model to be used for generating a response based on one of conditions input from a user among from a plurality of models for generating responses to inquiries, the models being for generating the responses corresponding to the conditions that are different from one another. The generation apparatus includes a generation unit that generates the response to an inquiry from the user by using the model selected by the selection unit. The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating one example of an action effect exerted by an information processing apparatus according to an embodiment;

FIG. 2 is a diagram illustrating one example of a functional configuration included in the information processing apparatus according to the embodiment;

FIG. 3 is a diagram illustrating one example of information registered in a model database according to the embodiment;

FIG. 4 is a diagram illustrating one example of information registered in a teacher-data database according to the embodiment;

FIG. 5 is a flowchart illustrating one example of a procedure for generation processes to be executed by the information processing apparatus according to the embodiment;

FIG. 6 is a flowchart illustrating one example of a procedure for learning processes to be executed by the information processing apparatus according to the embodiment; and

FIG. 7 is a diagram illustrating one example of processes, of the information processing apparatus according to the embodiment, for acquiring a condition.

### DETAILED DESCRIPTION OF THE PREFERRED EMBODIMENTS

Hereinafter, a mode (hereinafter, may be referred to as “embodiment”) for execution of a generation apparatus, a generation method, and a non-transitory computer readable storage medium according to the present application will be specifically explained with reference to the accompanying drawings. The generation apparatus, the generation method, and the non-transitory computer readable storage medium according to the present application are not limited to this embodiment. Note that in the following embodiment, common parts and processes are represented with the same symbols and the duplicated description is omitted appropriately.

In the following explanation, one example of a process for receiving, from a user U01, an inquiry associated with a love advice between the user U01 and another user as an inquiry related to the other user will be described as one example of generation processes to be executed by an information processing apparatus 10 that is one example of the generation apparatus, however, the embodiment is not limited thereto. For example, the information processing apparatus 10 may execute generation processes to be mentioned later when receiving an inquiry not associated with a user to be the other person (another user etc.) of the user U01.

### 1. Concept of Generation Processes

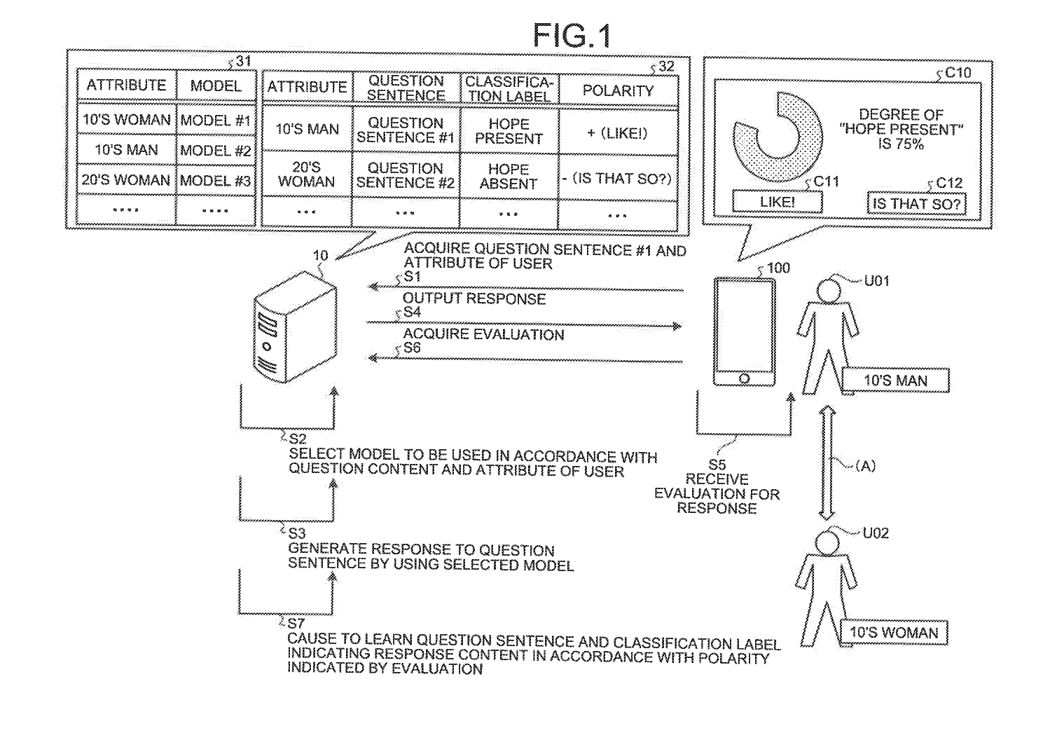

First, with reference to FIG. 1, a concept of the generation processes to be executed by the information processing apparatus 10 will be explained. FIG. 1 is a diagram illustrating one example of an action effect exerted by the information processing apparatus according to the embodiment. For example, the information processing apparatus 10 is an information processing apparatus that is realized by a server apparatus, a cloud system, one or more information processing apparatuses, etc. so as to communicate with a terminal device 100 used by the user U01 through a network N such as a mobile communication network and a wireless Local Area Network (wireless LAN).

The terminal device 100 is a mobile terminal such as a smartphone, a tablet terminal, and a Personal Digital Assistant (PDA), or an information processing apparatus such as a notebook-size personal computer. For example, when receiving an inquiry sentence (hereinafter, may be referred to as “question”) input the user U01 through a predetermined User Interface (UI), the terminal device 100 transmits the received question to the information processing apparatus 10.

On the other hand, when receiving a question from the terminal device 100, the information processing apparatus 10 generates a sentence (hereinafter, may be simply referred to as “response”) to be a response to the question, and transmits the generated response to the terminal device 100. For example, the information processing apparatus 10 generates a response according to the question content by using an artificial-intelligence-related technology such as a word2vec (w2v) and deep learning, and outputs the generated response. In a more specific example, the information processing apparatus 10 preliminary learns a model for estimating a response content when a question is input. The information processing apparatus 10 estimates a response content to a question received from a user by using the model, and outputs the response according to the estimation result.

However, there exists, in some cases, a case where questions have conditions to be determination references which are different from each other. Exemplifying specific example, in a question such as a love advice, which is related to relation between a user to be a questioner and another user, a response to the question is changed in some cases in accordance with an attribute such as ages and genders of the user or the other user.

For example, as illustrated by (A) in FIG. 1, the information processing apparatus 10 preliminary learns a model for estimating whether or not a user U02 has a favor to the user U01 by using information (hereinafter, may be referred to as “estimation information”) to be a source of an estimation of whether or not the user U02 has a favor to the user U01, such as (i) an action of the user U01 performed on the user U02, (ii) an action of the user U02 performed on the user U01, and (iii) relationship and a state between the user U01 and the user U02. When acquiring a question including estimation information from the user U01, the information processing apparatus 10 outputs, by using the model, a response indicating whether or not the user U02 has a favor to the user U01, which is determined by the acquired estimation information.

However, for example, when the user U01 and the user U02 are in their 20's, a content of estimation information recalls the fact that the user U02 has a favor to the user U01, when the user U01 and the user U02 are in their 30's, the content of estimation information does not always recall the fact that the user U02 has a favor to the user U01.

Moreover, the response may be changed in accordance with various conditions such as (i) a timing when the action is performed on the user U01 by the user U02 and (ii) a difference in age between the user U01 and the user U02, as well as attributes of the user U01 and the user U02. Thus, when responses to questions are generated by one model as in a conventional technology, accuracy in the responses is worsened.

### 2. Generation Processes to be Executed by Information Processing Apparatus According to Embodiment

The information processing apparatus 10 executes the following generation processes. For example, the information processing apparatus 10 selects a model to be used for generating a response on the basis of a condition input by the user U01 among from a plurality of models for generating responses to questions and for generating responses corresponding to conditions that are different from one another. The information processing apparatus 10 generates a response to a question from the user U01 by using the selected model. The information processing apparatus 10 transmits the generated response to the terminal device 100 of the user U01.

Hereinafter, with reference to the drawings, one example of a functional configuration and an action effect of the information processing apparatus 10 that realizes the above generation processes will be explained. In the following explanation, estimation information for estimating a response is assumed to be included in a question acquired from the user U01.

### 2-1. One Example of Functional Configuration

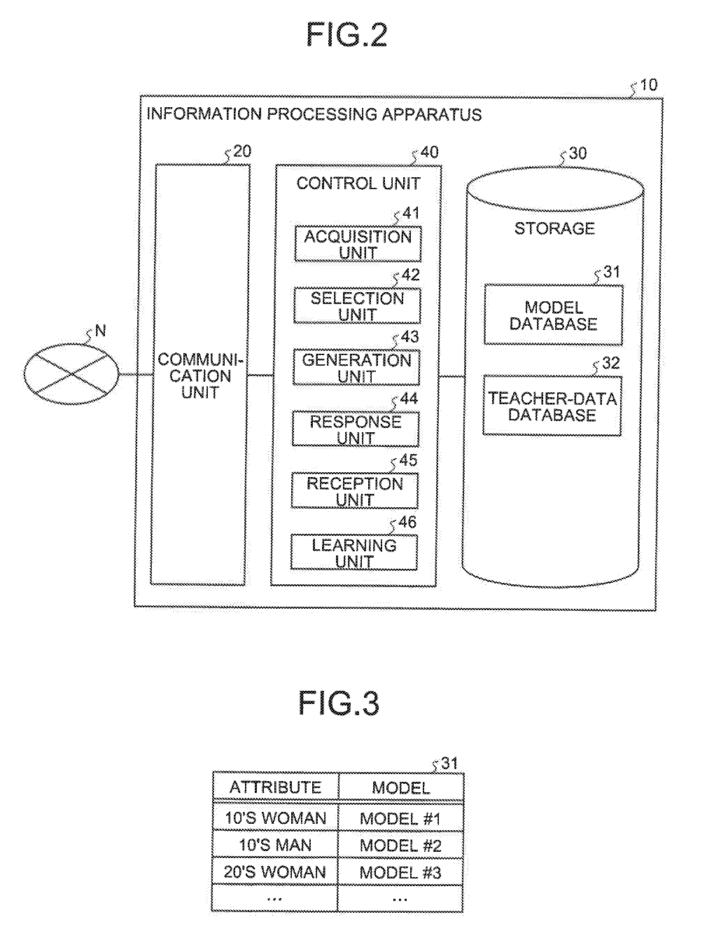

FIG. 2 is a diagram illustrating one example of a functional configuration included in the information processing apparatus according to the embodiment. As illustrated in FIG. 2, the information processing apparatus 10 includes a communication unit 20, a storage 30, and a control unit 40. The communication unit 20 realizes by, for example, a Network Interface Card (NIC) etc. The communication unit 20 is connected with the network N in a wired or wireless manner so as to transmit/receive a question and a response to/from the terminal device 100.

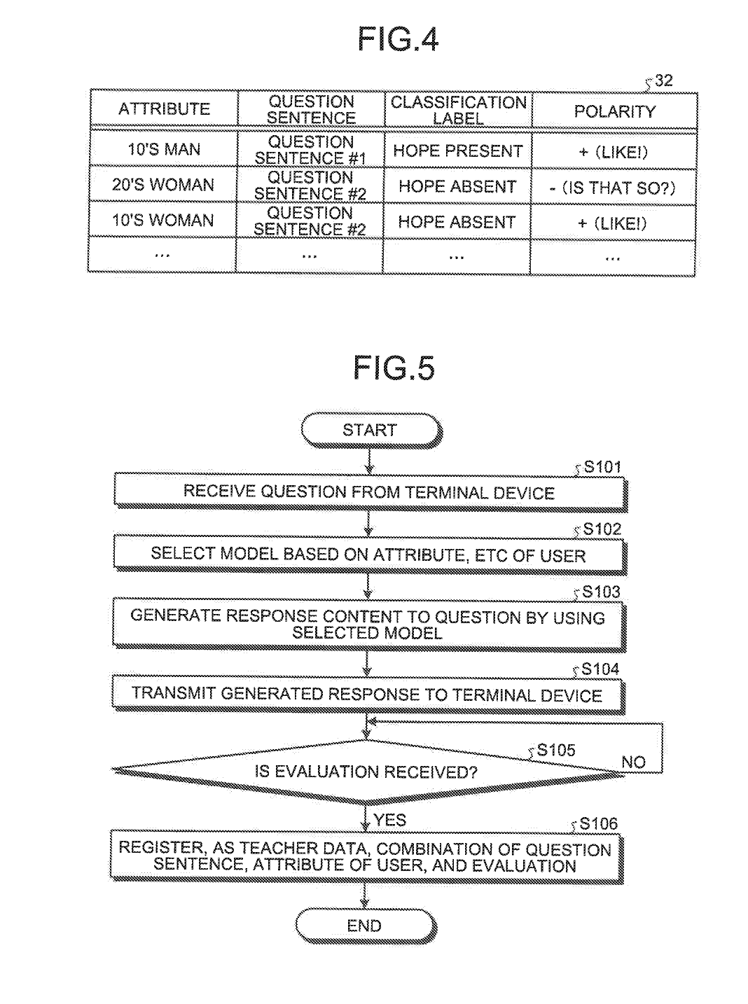

The storage 30 is realized by (i) a semiconductor memory element such as a Random Access Memory (RAM) and a Flash Memory or (ii) a storage such as a hard disk drive and an optical disk. The storage 30 includes a model database 31 and a teacher-data database 32 that are various data for executing the generation processes. Hereinafter, with reference to FIGS. 3 and 4, one example of information registered in the model database 31 and the teacher-data database 32 will be explained.

In the model database 31, a plurality of models for generating responses to inquiries on the basis of conditions input by users and for generating the responses corresponding to conditions that are different from one another is registered. For example, in the model database 31, a model for generating a response corresponding to an attribute of a user as a questioner, a user as the other person with respect to the question, etc. are registered. As an attribute of a user, not only a demographic attribute such as a gender, an age, a resident area, and a birthplace of the user, but also a psychographic attribute such as a taste of the user, namely any arbitrary attribute expressing the user may be employed.

In the model database 31, a model for outputting, in response to a question from the user U01, either of a predetermined response and a response having a content reverse to that of the predetermined response is registered. For example, when receiving a question having a content of, for example, whether or not a user to be a questioner (for example, the user U01) is interested by a user to be the other person (for example, the user U02), a model registered in the model database 31 outputs, on the basis of estimation information, a response indicating the fact that the user to be the questioner is “hope present (interested)” or an estimation result indicating the fact that the user to be the questioner is “hope absent (uninterested)”.

For example, FIG. 3 is a diagram illustrating one example of information registered in the model database according to the embodiment. As illustrated in FIG. 3, in the model database 31, information including item, such as “model” and “attribute”, is registered. Here “model” is a model generated by, for example, Deep Neural Network (DNN) etc. Moreover, “attribute” is information indicating under what condition the associated model generates a response. In other words, each of the models registered in the model database 31 outputs a response having high possibility that a user having an attribute indicated by the associated “attribute” is satisfied with the response, in other words, a response that is optimized for an attribute indicated by the associated “attribute”.

For example, in the example illustrated in FIG. 3, an attribute “10's woman” and a model “model #1” are registered in the model database 31 in association with each other. Such information indicates the fact that learning is performed so that the model #1 outputs a response that is optimized for a woman in her 10's in response to a question from a user. A model registered in the model database 31 is assumed to be optimized for a user on a side of putting a question.

In the teacher-data database 32, teacher data to be used for learning the models are registered. Specifically, in the teacher-data database 32, questions received by the information processing apparatus 10 from users, responses to the questions, and information indicating evaluations of the responses are registered as teacher data.

For example, FIG. 4 is a diagram illustrating one example of information registered in the teacher-data database according to the embodiment. As illustrated in FIG. 4, in the teacher-data database 32, information including items such as “attribute”, “question sentence”, “classification label”, and “polarity” is registered. Here “attribute” illustrated in FIG. 4 is information indicating an attribute of a user that puts a question. Here “question sentence” is a sentence of a question input by a user, in other words, text data.

Moreover, “classification label” is information indicating a content of a response output by a model in response to a question indicated by the associated “question sentence”. For example, when text data of “question sentence” is input, each of the models classifies the “question sentence” into either of “hope present” or “hope absent” on the basis of a content of estimation information included in the input text data. The information processing apparatus 10 generates a response on the basis of a classification result by each of the models. For example, when “question sentence” is input, each of the models classifies the input “question sentence” into “hope present” or “hope absent”. When “question sentence” is classified into “hope present”, the information processing apparatus 10 generates a response indicating the fact of “hope present”, when “question sentence” is classified into “hope absent”, the information processing apparatus 10 generates a response indicating the fact of “hope absent”.

Here “polarity” is information indicating an evaluation of a user for a response output by the information processing apparatus 10. Specifically, “polarity” is information indicating whether a user performs a positive evaluation (for example, “like!” etc.) or a negative evaluation (for example, “Is that so?” etc.) for a content of the response.

For example, in the example illustrated in FIG. 4, an attribute “10's man”, a question sentence “question sentence #1”, a classification label “hope present”, a polarity “+(like!)”, etc. are registered in the teacher-data database 32 in association with one another. Such information indicates the fact that an attribute of a user that puts a question is “10's man”, a question sentence is “question sentence #1”, and a response content is “hope present”. Such information indicates the fact that the user that puts the question performs a positive evaluation (“+(like!)”) on the response having the content of “hope present”.

Returning to FIG. 2, the explanation will be continued. Various programs stored in a storage provided in the information processing apparatus 10 by using, for example, a Central Processing Unit (CPU), a Micro Processing Unit (MPU), an Application Specific Integrated Circuit (ASIC), a Field Programmable Gate Array (FPGA), etc. are executed while using a storage region such as a RAM as a work region, so that the control unit 40 is realized. In the example illustrated in FIG. 2, the control unit 40 includes an acquisition unit 41, a selection unit 42, a generation unit 43, a response unit 44, a reception unit 45, and a learning unit 46 (hereinafter, may be collectively referred to as “processing units 41 to 46”).

Connection relation between the processing units 41 to 46 included in the control unit 40 is not limited to that illustrated in FIG. 2, and may employ other connection relation. The processing units 41 to 46 realize/execute functions/actions (see FIG. 1) of generation processes and learning processes to be mentioned in the following, they are functional units put in order for convenience of explanation, and it does not matter whether any of the units coincide with actual hardware elements or software modules. In other words, when the following functions/actions of the generation processes and learning processes are realized/executed, the information processing apparatus 10 may realize/execute the processes by using an arbitrary functional unit.

### 2-2. One Example of Action Effect of Generation Processes

Hereinafter, with reference to the flowchart illustrated in FIG. 5, contents of the generation processes to be executed/realized by each of the processing units 41 to 45 will be explained. FIG. 5 is a flowchart illustrating one example of a procedure for the generation processes to be executed by the information processing apparatus according to the embodiment.

First, the acquisition unit 41 receives a question from the terminal device 100 (Step S101). For example, as Step S1 illustrated in FIG. 1, the information processing apparatus 10 acquires the question sentence #1 and an attribute (“10's man”) of the user U01 from the terminal device 100. The information processing apparatus 10 may automatically acquire an attribute of the user U01 by using a technology such as a B Cookie or may cause the user U01 to input the attribute. For example, the information processing apparatus 10 may cause the terminal device 100 to display a sentence such as “Please teach your information” so as to cause the user U01 to input an attribute. In other words, the information processing apparatus 10 may cause the user U01 to input an attribute so as to select a model to be used in generating a response.

In this case, the selection unit 42 selects a model to be used in generating a response on the basis of an attribute etc. of the user U01 (Step S102). In other words, the selection unit 42 selects a model to be used in generating a response on the basis of a condition input by the user U01 among from a plurality of models including models for generating responses to inquiries and for generating responses corresponding to conditions that are different from one another.

Specifically, the selection unit 42 selects a model to be used for generating a response on the basis of an attribute of the user U01 among from models for generating responses corresponding to attributes that are different from one another. For example, the selection unit 42 selects a model for generating a response corresponding to the same attribute as that of the user U01 that puts a question. The selection unit 42 may request the user U01 to input a condition such as an attribute so as to select a model to be used for generating a response among from the models on the basis of the attribute input by the user U01. As a result of such a selection, the selection unit 42 selects, as a model, a model to be used for generating a response among from models for outputting, in response to a question from the user U01, either of a predetermined response and a response having a content reverse to that of the predetermined response.

For example, as Step S2 illustrated in FIG. 1, when receiving from the user U01 a question sentence related to relationship between the user U01 and the user U02, the information processing apparatus 10 specifies an attribute (“10's man”) of the user U01. The information processing apparatus 10 selects a model #2 associated with the attribute “10's man”, in other words, the model #2 for generating a response optimized for the attribute “10's man”.

When the selection unit 42 selects the model, the generation unit 43 generates a response content to the question by using the selected model (Step S103). For example, the generation unit 43 inputs a question sentence to the model and generates a response on the basis of a classification result of the question sentence by using the model. For example, as Step S3 illustrated in FIG. 1, the information processing apparatus 10 generates a response to the question from the user U01 by using the selected model #2.

Exemplifying more specific example, the information processing apparatus 10 inputs, to the model #2, the question sentence #1 received from the user U01. In this case, the model #2 outputs a classification label (“hope present”) as a response optimized for the attribute (“10's man”). The model #2 outputs a value indicating possibility that a response content indicated by the classification label (“hope present”) is correct, in other words, a reliability value.

The information processing apparatus 10 generates a content response indicated by the classification label (“hope present”). For example, the information processing apparatus 10 generates a response C10 indicating the fact that the user U02 has a favor to the user U01 and a reliability output by the model #2. Exemplifying more specific example, the information processing apparatus 10 generates information indicating a reliability output by a model as the response C10, for example, “degree of hope present is 75%” etc., along with a response of “hope present” or “hope absent”.

The response unit 44 transmits the generated response to the terminal device 100 (Step S104). For example, as Step S4 illustrated in FIG. 1, the information processing apparatus 10 outputs the generated response to the terminal device 100.

Next, the reception unit 45 determines whether or not the reception unit 45 receives an evaluation for the response from the terminal device 100 (Step S105). When not receiving any evaluation (Step S105: No), the reception unit 45 waits for reception of an evaluation. When receiving an evaluation for the response (Step S105: Yes), the reception unit 45 registers a combination of the question sentence, the attribute of the user U01, and the evaluation in the teacher-data database 32 as teacher data (Step S106), and terminates the process.

For example, in the response C10 illustrated in FIG. 1, a button C11 for receiving a positive evaluation such as “like!” and a button C12 for receiving a negative evaluation such as “Is that so?” are arranged. In this case, as Step S5 illustrated in FIG. 1, the terminal device 100 displays the response C10 on the screen, and receives the evaluation for the response. When the user U01 selects either of the button C11 or the button C12, as Step S6 illustrated in FIG. 1, the information processing apparatus 10 acquires the evaluation indicated by the button that is selected by the user U01.

The information processing apparatus 10 registers, in the teacher-data database 32 as teacher data, a combination of the attribute (“10's man”) of the user U01, the question sentence (“question sentence #1”) input by the user U01, the classification label (“hope present”) indicating a response content output by the selected model #2, and the polarity “+(like!)” indicating the evaluation of the user U01.

The information processing apparatus 10 executes the learning processes for learning models registered in the model database 31 by using the teacher data registered in the teacher-data database 32. Specifically, as Step S7 illustrated in FIG. 1, the information processing apparatus 10 executes learning processes for causing the models to learn, in accordance with the polarity indicated by the evaluation, a combination of (i) a classification label indicating the response content, in other words, a classification label indicating a classification result of the question sentence and (ii) the question sentence.

### 2-3. One Example of Action Effect in Learning Processes

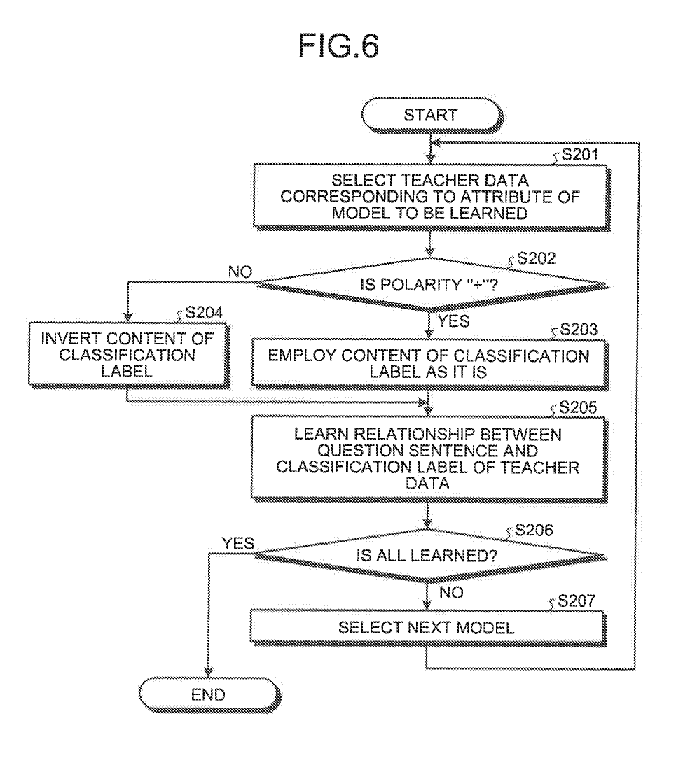

Hereinafter, contents of acquisition processes to be executed/realized by the learning unit 46 will be explained by using the flowchart illustrated in FIG. 6. FIG. 6 is a flowchart illustrating one example of a procedure for the learning processes to be executed by the information processing apparatus according to the embodiment. The learning unit 46 executes the learning processes illustrated in FIG. 6 so as to learn a model by using a question from the user U01, a response generated in response to the question, and an evaluation for the response.

For example, the learning unit 46 selects teacher data that corresponds to an attribute of a model to be learned (Step S201). In other words, the learning unit 46 learns a model for generating a response that is corresponding to a condition input by the user U01 by using a question from the user U01, a response generated in response to the question, and an evaluation for the response.

For example, the learning unit 46 selects one non-learned model with reference to the model database 31. The learning unit 46 extracts, with reference to an attribute of the selected model, all of the teacher data including the same attribute as that is referred from the teacher-data database 32. In other words, the learning unit 46 learns a model for generating a response corresponding to the condition input by the user U01 on the basis of the response corresponding to the condition and the evaluation for the response.

The learning unit 46 determines whether or not a polarity of the selected teacher data is “+” (Step S202). When the polarity is “+” (Step S202: Yes), the learning unit 46 employs the content of the classification label as teacher data as it is (Step S203). On the other hand, when a polarity is not “+” (Step S202: No), the learning unit 46 inverts the content of the classification label (Step S204). For example, in a case where a polarity is “−”, when a classification label is “hope present”, the learning unit 46 changes the classification label into “hope absent”. In a case where a polarity is “−”, when a classification label is “hope absent”, the learning unit 46 changes a classification label into “hope present”.

The learning unit 46 causes a model to learn relationship between a question sentence and a classification label of teacher data (Step S205). In other words, when an evaluation for a response is a positive evaluation, the learning unit 46 causes a model to learn a question from the user U01 and a response generated in response to the question. On the other hand, when an evaluation for a response is a negative evaluation, the learning unit 46 causes a model to learn a question from the user U01 and a response having a content reverse to that of a response generated in response to the question.

For example, when learning a model #3 illustrated in FIG. 1, the learning unit 46 specifies an attribute (“20's woman”) corresponding to the model #3, and extracts teacher data that is associated with the specified attribute (“20's woman”). As a result, the learning unit 46 extracts teacher data in which an attribute of the teacher data is “20's woman”, a question sentence of the teacher data is “question sentence #2”, a classification label of the teacher data is “hope absent”, and a polarity of the teacher data is “-(Is that so?)”. Here the polarity of the extracted teacher data is “-(Is that so?)”, and thus the learning unit 46 converts the classification label from “hope absent” to “hope present”. The learning unit 46 adjusts the model #3 such that the model #3 outputs the classification label (“hope present”) when a question sentence “question sentence #2” is input to the model #3. Specifically, when the model #3 is realized by a Deep Neural Network (DNN) etc., the learning unit 46 modifies connection coefficients between nodes included in the model #3 by using a known learning method such as back propagation so as to learn the model #3 again.

For example, when learning the model #2 illustrated in FIG. 1, the learning unit 46 specifies the attribute (“10's man”) corresponding to the model #2, and extracts teacher data that is associated with the specified attribute “10's man”. As a result, the learning unit 46 extracts teacher data in which an attribute of teacher data is “10's man”, a question sentence is “question sentence #1”, a classification label is “hope present”, and a polarity is “+(like!)”. Here a polarity of the extracted teacher data is “+(like!)”, the learning unit 46 keeps the classification label “hope present”. When inputting the question sentence “question sentence #1” to the model #2, the learning unit 46 adjusts the model #2 such that the model #2 outputs the classification label (“hope present”).

As a result of these processes, the learning unit 46 can acquire a classification model for classifying a question sentence into “hope present” or “hope absent” in accordance with a condition, when the question sentence is input. Specifically, when a question sentence including estimation information is input, the learning unit 46 can learn a model that is for outputting information indicating whether the user U02 has a favor to the user U01 (in other words, “hope present”) or the user U02 does not have any favor to the user U01 (in other words, “hope absent”) and is optimized in accordance with an attribute of each user.

The learning unit 46 determines whether or not all of the models have been learned (Step S206), when all of the models have been learned (Step S206: Yes), terminates the process. On the other hand, when there exists a non-learned model (Step S206: No), the learning unit 46 selects the next model to be learned (Step S207) so as to execute the process of Step S201.

The learning unit 46 may execute the learning process illustrated in FIG. 6 at an arbitrary timing. For example, the learning unit 46 may execute the learning process at a timing when the number of the teacher data exceeds a predetermined threshold.

In the above explanation, when a question sentence is input, the learning unit 46 included in the information processing apparatus 10 learns a model such that the learning unit 46 outputs a classification label according to a content of the question sentence. However, the embodiment is not limited thereto. For example, when a question sentence is input, the information processing apparatus 10 may learn a model that outputs a response sentence as it is having a content indicated by a classification label according to a content of the question sentence.

For example, when a question sentence is “question sentence #1”, a response sentence that is a text to be output as a response is “response sentence #1”, and there exists teacher data whose polarity is “+(like!)”, the information processing apparatus 10 learns a model such that the response sentence outputs “response sentence #1” when the question sentence “question sentence #1” is input. When the question sentence is “question sentence #1”, the response sentence is “response sentence #1”, and there exists teacher data whose polarity is “-(Is that so?)”, the information processing apparatus 10 learns a model such that the response sentence outputs “response sentence #2” having a meaning reverse to that of “response sentence #1” when the question sentence “question sentence #1” is input. For example, the information processing apparatus 10 preliminary generates “response sentence #2” having a meaning reverse to that of “response sentence #1” by using a technology of morphological analysis, a technology of w2v, etc., and further learns a model such that the response sentence outputs “response sentence #2” when the question sentence “question sentence #1” is input. For example, the information processing apparatus 10 can learn a model that outputs a response sentence by a process similar to that for generating a model that is for performing ranking in a search process such as a web search. When performing such learning, the information processing apparatus 10 collects teacher data in which a question sentence “question sentence #1”, a response sentence “response sentence #1”, and a polarity “+(like!)” are associated with one another.

The information processing apparatus 10 may input a polarity along with a question sentence to a model so as to learn a model for outputting from the question sentence a classification label and a response sentence according to the polarity. For example, the information processing apparatus 10 may learn a model that outputs, when a question sentence “question sentence #1” and the polarity “+(like!)” are input, the classification label (“hope present”) and the response sentence “response sentence #1”, and outputs, when the question sentence “question sentence #1” and the polarity “-(Is that so?)” are input, the classification label “hope absent” and the response sentence “response sentence #2”.

In other words, in a case of a plurality of models for generating a response to an inquiry on the basis of a condition input by a user, the information processing apparatus 10 may use and learn not only a model for generating information to be used for generating the response, but also a model for generating the response as it is. When learning a model in consideration of a polarity (in other words, evaluation of user for response sentence) included in teacher data, the information processing apparatus 10 may learn, for example, the model by using teacher data converted in accordance with the polarity, or may cause a model to learn a value of the polarity as it is as teacher data.

### 3. Modification

The information processing apparatus 10 according to the above embodiment may be performed in various different modes other than the above embodiment. Hereinafter, an embodiment other than the above information processing apparatus 10 will be explained.

### 3-1. Selection of Model

The information processing apparatus 10 selects a model optimized for an attribute of the user U01, and generates a response to the user U01 by using the selected model. However, the embodiment is not limited thereto. For example, the information processing apparatus 10 may select a model for generating a response on the basis of an arbitrary selection reference other than an attribute of the user U01.

For example, the information processing apparatus 10 may select a model for generating a response corresponding to an attribute that is different from an attribute of the user U01. For example, in a case where a question related to a love advice is received, when an attribute of the user U01 is “10's man”, an attribute of the user U02, which is the other person, is estimated to be “10's woman”. When an attribute of the user U01 is “10's man”, the information processing apparatus 10 may select a model that is optimized for the attribute “10's woman”, and may generate a response from estimation information by using this selected model.

For example, in a case where a question related to relation with a superior is received, when an attribute of the user U01 is “20's man”, the information processing apparatus 10 estimates an attribute of the user U02, which is the other person, to be “30's man”. When an attribute of the user U01 is “20's man”, the information processing apparatus 10 may select a model that is optimized for an attribute “30's man”, and may generate a response from estimation information by using the selected model.

When an attribute of the user U02 to be the other person can be specified, the information processing apparatus 10 may select a model optimized for this attribute. In other words, when receiving an inquiry related to the other user U02 from the user U01, the information processing apparatus 10 may select, on the basis of an attribute of this other user U02, a model to be used for generating a response among from models for generating responses corresponding to different attributes. For example, the information processing apparatus 10 may output a response such as “please teach age and gender of fellow” so as to cause the user U01 to input attributes such as an age and a gender of the user U02 to be the other person. The information processing apparatus 10 may select a model optimized for the input attributes so as to output a response.

For example, the information processing apparatus 10 may cause the user U01, which puts a question, to select a model to be used. In other words, the information processing apparatus 10 may select a model for generating a response corresponding to a condition selected by the user U01. For example, the information processing apparatus 10 presents “attributes” registered in the model database 31 to a user, and inquires of the user which of the attributes the user selects to generate a response by using a model corresponding to the selected “attribute”. The information processing apparatus 10 may generate a response by using a model optimized for the “attribute” selected by the user, in other words, a model optimized for a condition selected by the user.

The information processing apparatus 10 may select a plurality of models, and further may generate a response by using the selected plurality of models. For example, when estimation information is input to each of the models, the information processing apparatus 10 may select a model to be used for generating a response on the basis of a reliability output from the corresponding model. In other words, the information processing apparatus 10 may select a model for generating a response to a question on the basis of a value of a reliability output from each of the models in response to a question from the user U01 among from the plurality of models for outputting responses and reliabilities of the responses.

For example, when receiving a question including estimation information from the user U01, the information processing apparatus 10 inputs the estimation information to each of the models #1 to #3, and acquires a response and a reliability of corresponding one of the models #1 to #3. For example, it is assumed that the model #1 outputs the classification label (“hope present”) and a reliability “0.75”, the model #2 outputs the classification label “hope absent)” and a reliability “0.65”, and the model #3 outputs the classification label (“hope present”) and a reliability “0.99”. In this case, the information processing apparatus 10 may select the model #3 whose value of the reliability is the largest so as to generate a response based on the classification label (“hope present”) output from the model #3.

For example, the information processing apparatus 10 may generate responses to a question from the user U01 and reliabilities of the responses by using a plurality of models, respectively, may compute an average value of the reliabilities for each of the contents of the generated responses, and may output a response having a content whose value of the computed average value is the highest. For example, it is assumed that the model #1 outputs the classification label (“hope present”) and the reliability “0.75”, the model #2 outputs the classification label “hope absent” and the reliability “0.65”, and the model #3 outputs the classification label (“hope present”) and the reliability “0.99”, the information processing apparatus 10 computes an average value “0.87” of the reliabilities of the classification label (“hope present”) and an average value “0.65” of the reliabilities of the classification label “hope absent”. The information processing apparatus 10 may generate a response based on the classification label (“hope present”) whose value of the reliability average value is higher.

For example, when an attribute of the user U01 includes “man”, the information processing apparatus 10 may selects all of the models including “man” in their attributes, and may generate a response by using a model having a higher reliability value among the selected plurality of models. When an attribute of the user U01 includes “10's”, the information processing apparatus 10 may selects all of the models including “10's” in their attributes, and may generate a response by using a model having a higher reliability value among the selected plurality of models.

The information processing apparatus 10 may preliminary learn models optimized for conditions having arbitrary granularities, and may acquire response contents (“hope present”, “hope absent”, etc.) to a question by using all of these models. The information processing apparatus 10 may decide the response content on the basis of a majority vote of the acquired contents and a majority vote based on reliabilities of the contents. The information processing apparatus 10 may decide a response content in consideration of weighting based on an attribute of the user U01 to be a questioner, an attribute of the user U02, a response content or a reliability value estimated by each of the models, etc.

### 3-2. Model

In the above example, the information processing apparatus 10 learns and uses models for responding, to a user of a questioner, whether a user to be the other person is “hope present” or “hope absent”. However, the embodiment is not limit thereto. In other words, the information processing apparatus 10 may learn and use models optimized for various conditions in accordance with types of questions.

For example, the information processing apparatus 10 may learn and use a model for generating a response to a question related to human relation in a company. In this case, the information processing apparatus 10 may learn a model for estimating whether or not a user to be the other person is fond of a user of a questioner on the basis of an attribute of the user of the questioner, an attribute of the user to be the other person, and a content of estimation information. The information processing apparatus 10 may learn a model optimized for not only an attribute of a user of a questioner, but also an attribute of a user to be the other person.

The information processing apparatus 10 may learn and use a model for generating a response to a question related to job hunting. For example, the information processing apparatus 10 holds a model that is for estimating whether or not a user of a questioner can get a job on the basis of contents of a university and a major of a user of a questioner as estimation information and is optimized for each company. When receiving selection of a company in which a user wished to work along with contents of a university and a major of the user, the information processing apparatus 10 may output, as a response, an estimation result of whether or not the user can get a job by using a model optimized for this company.

The information processing apparatus 10 may use and learn a model for generating a response to a question having an arbitrary content other than the above content. In other words, when a model is selected which is for generating a response in accordance with a condition (for example, attribute of questioner, attribute of another person, etc.) based on an input of a user among from a plurality of models optimized for each of the conditions, the information processing apparatus 10 may use and learn a model for generating a response to a question having an arbitrary content.

### 3-3. Attribute

The above information processing apparatus 10 learns, from estimation information, a plurality of models for outputting responses optimized for respective attributes of users, and selects a model for outputting a response optimized for an attribute of a user that puts a question. However, the embodiment is not limited thereto. For example, when a model is for estimating whether or not a user to be the other person has a favor, the information processing apparatus 10 may learn, from estimation information, a model for performing an estimation optimized for an arbitrary condition.

For example, when the user U02 performs an action on the user U01, the action is estimated that the user U02 has a favor to the user U01 in some area, however, the action is estimated that the user U02 does not have any favor to the user U01 in another area. Therefore, the information processing apparatus 10 may select, on the basis of an area in which the user U01 exists, a model for generating a response (in other words, response optimized for each area) among from models for generating responses corresponding to areas that are different from one another.

For example, the information processing apparatus 10 learns for each predetermined area, on the basis of estimation information, a model for estimating whether or not a user to be the other person has a favor. When receiving a question including estimation information from the user U01, the information processing apparatus 10 specifies a location of the user U01 by using a positioning system such as a Global Positioning System (GPS). The information processing apparatus 10 may output a response such as “Where are you living?” so as to cause the user U01 to input an area where the user U01 exists. When specifying a location of the user U01, the information processing apparatus 10 may generate a response to a question received from the user U01 by using a model corresponding to the specified area.

### 3-4. Learning Process

In the above processes, the information processing apparatus 10 learns a model optimized for an attribute of a user of a questioner by using a content of a response as it is or by using an inverted content in accordance with an evaluation for the response received from the user that is the questioner. However, the embodiment is not limited thereto.

For example, when an attribute of a user to be the other person in a question can be specified, the information processing apparatus 10 may learn a model optimized for the attribute of the user to be the other person by using, as teacher data, the question, a response to the question, and an evaluation for the response. For example, when receiving from the user U01 a question related to the user U02, the information processing apparatus 10 may learn the model #1 corresponding to the attribute (“10's woman”) of the user U02 on the basis of the question, a response to the question, and an evaluation for the response.

Similarly to the above modification of the selection processes, the information processing apparatus 10 may learn a model optimized for an attribute that is different from that of a user of a questioner, by using a question, a response to the question, and an evaluation for the response. For example, when an attribute of the user U01 that is a questioner is “10's man”, the information processing apparatus 10 may learn a model optimized for “10's woman” on the basis of a question of the user U01, a response to the question, and an evaluation for the response.

The information processing apparatus 10 may use and learn not only a model for performing classification using two values of “hope present” and “hope absent”, but also a model for performing classification using three or more values including “hope present”, “hope absent”, and “unknown”. In a case where such a model is learned, when a polarity of a response is “+”, the information processing apparatus 10 may use, as teacher data, a question and a content (classification result label) of the response as it is, so as to learn a model.

When a polarity for a response is “−”, the information processing apparatus 10 may generate teacher data obtained by associating a content other than a content of the response and a question with each other, so as to learn a model by using the generated teacher data. For example, when a content of a response to a question is “hope present” and a polarity of the response is “−”, the information processing apparatus 10 may learn a model by using teacher data obtained by associating the question and a content (“hope absent”) of the response with each other, and teacher data obtained by associating the question and a content (“unknown”) of the response with each other.

### 3-5. Determination of Off-Topic

The information processing apparatus 10 may learn and use a model for determining off-topic in addition to the above processes. For example, when receiving a question, the information processing apparatus 10 determines whether or not a field to which the question is belonging is a love advice, by using an arbitrary sentence-analyzing technology. When a field to which the question is belonging is a love advice, the information processing apparatus 10 may select a model in accordance with an attribute of a questioner and an attribute of the other person so as to output a response to the question by using the selected model.

The information processing apparatus 10 may learn and use, from an input question, a model for estimating any one of “hope present”, “hope absent”, and “off-topic”, for example. In this case, when the model outputs the fact indicating “off-topic”, the information processing apparatus 10 may inform a questioner of the fact indicating that a response is not performed, and may output a response encouraging, for example, the questioner to input another question.

### 3-6. Acquisition of Condition

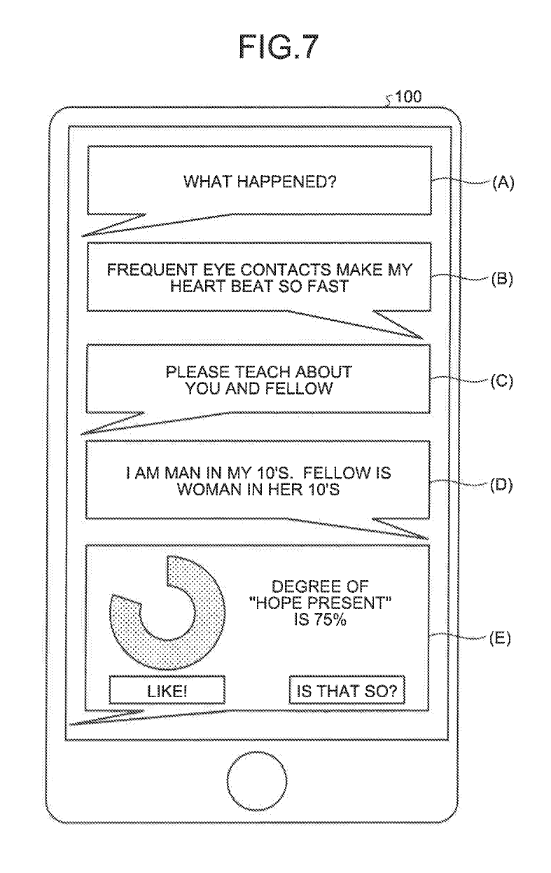

The information processing apparatus 10 may progress a conversation with a questioner so as to acquire a condition for selecting a model, such as an attribute of the questioner and an attribute of the other person. For example, FIG. 7 is a diagram illustrating one example of processes, of the information processing apparatus according to the embodiment, for acquiring a condition. In FIG. 7, examples of messages and sentences (in other words, “questions”) are illustrated. The information processing apparatus 10 causes the terminal device 100 to display the messages and the terminal device 100 receives the sentences from the user U01.

For example, as illustrated by (A) in FIG. 7, the information processing apparatus 10 causes, for example, the terminal device 100 to display a message for encouraging, for example, a questioner to input a question including estimation information, such as “What happened?”. As illustrated by (B) in FIG. 7, the user U01 is assumed to input a message including estimation information such as “Frequent eye contacts make my heart beat so fast”. In this case, as illustrated by (C) in FIG. 7, the information processing apparatus 10 causes, for example, the terminal device 100 to display a message for encouraging, for example, a questioner to input information (in other words, “condition”) on the user U01 and a user to be the other person, such as “Please teach about you and fellow”.

As illustrated by (D) in FIG. 7, the user U01 is assumed to input a message such as “I am man in my 10's. Fellow is woman in her 10's”. In this case, the information processing apparatus 10 specifies, from the message input from the user U01, the fact that an attribute of the user U01 is “10's man” and an attribute of a user to be the other person is “10's woman”. The information processing apparatus 10 selects a model for generating a response on the basis of the specified attribute of the user U01 and the specified attribute of the user to be the other person so as to generate a response by using the selected model. As illustrated by (E) in FIG. 7, the information processing apparatus 10 presents “hope present” or “hope absent”, and the degree of reliability, and causes, for example, the terminal device 100 to display the response C10 for receiving an evaluation from the user U01.

### 3-7. Reception of Evaluation

The information processing apparatus 10 receives, from the user U01 that has performed a question, an evaluation for a response to the question. However, the embodiment is not limited thereto. For example, the information processing apparatus 10 discloses the question from the user U01 and the response to the question and receives an evaluation from a third person. The information processing apparatus 10 may disclose the question from the user U01 and the response to the question, and further may learn a model by using the evaluation from the third person. For example, when an attribute of the third person is “woman 10's”, the information processing apparatus 10 may learn a model optimized for the attribute “woman 10's” by using the question from the user U01, the response to the question, and the evaluation from the third person. When performing such learning, the information processing apparatus 10 selects a model on the basis of the attribute of the user U02 to be the other person in response to the question from the user U01, so that it is possible to improve estimation accuracy in a response content.

### 3-8. Others

The above information processing apparatus 10 may learn and use an arbitrary model other than the above models. For example, the information processing apparatus 10 may learn a model that is for determining whether an input sentence is related to dogs or related to cats, and is optimized for each of the conditions (for example, genders of questioners) that are different from one another. The information processing apparatus 10 may learn a model that is for determining whether an input sentence is related to U.S. dollar or related to Euro, and is optimized for each of the conditions (for example, languages of input sentences) that are different from one another. The information processing apparatus 10 may learn a model that is for determining whether an input sentence is related to baseball or related to soccer, and is optimized for each of the conditions (for example, ages of questioners) that are different from one another.

For example, the information processing apparatus 10 may generate a plurality of models that are differently optimized for respective age differences each of which is between the user U01 of the questioner and the user U02 to be the other person, and may select a model for generating a response in accordance with an age difference between the user U01 of the questioner and the user U02 to be the other person. When learning such a model, the information processing apparatus 10 computes an age difference between the user U01 that puts a question and the user U02 to be the other person, and selects a model optimized for the computed age difference as a learning target. The information processing apparatus 10 may learn the selected model by using the question, the response, and the evaluation as teacher data.

The information processing apparatus 10 receives, from the user U01, not only an evaluation for a response but also a result for the response, and may perform weighting when a model is selected and when a model is learned on the basis of the received result. For example, the information processing apparatus 10 provides, to the user U01, a response indicating the fact that the user U02 is “hope present”. In this case, the information processing apparatus 10 inquires of the user U01 whether or not the user U02 has a favor to the user U01. When information indicating the fact that the user U02 has a favor to the user U01 is acquired from the user U01, the information processing apparatus 10 may adjust a model so as to output the fact indicating “hope present” in response to a question sentence input by the user U01. The information processing apparatus 10 may perform weighting so that reliability of a result of a model used in generating a response to a question sentence input by the user U01 is improved.

### 3-9. Other Embodiment

The above embodiment is merely an example, and the present disclosure includes what is exemplified in the following and other embodiments. For example, the functional configuration, the data configuration, the order and contents of the processes illustrated in the flowcharts, etc. are merely one example, and presence or absence of each of the units, arranges of the units, execution order of the processes of the units, specific contents of the units, etc. may be appropriately changed. For example, any of the above generation processes and learning processes may be realized as an apparatus, a method, or a program in a cloud system other than the case realized by the information processing apparatus 10 as described in the above embodiment.

The processing units 41 to 46, which configures the information processing apparatus 10, may be realized by respective independent devices. Similarly, the configurations according to the present disclosure may be flexibly changed. For example, the means according to the above embodiment may be realized by calling an external platform etc. by using an Application Program Interface (API) and a network computing (namely, cloud). Moreover, elements of means according to the present disclosure may be realized by another information processing mechanism such as a physical electronic circuit, not limited to a operation controlling unit of a computer.

The information processing apparatus 10 may be realized by (i) a front-end server that transmits and receives a question and a response to and from the terminal device 100 and (ii) a back-end server that executes the generation processes and the learning processes. For example, when receiving an attribute and a question of the user U01 from the terminal device 100, the front-end server transmits the received attribute and question to the back-end server. In this case, the back-end server selects a model on the basis of the received attribute, and further generates a response to the question by using the selected model. The back-end server transmits the generated response to the front-end server. Next, the front-end server transmits a response to the terminal device 100 as a message.

When receiving an evaluation for the response from the terminal device 100, the front-end server generates teacher data obtained by associating the received evaluation, the transmitted question, an attribute of the user (in other words, condition) with one another, and transmits the generated teacher data to the back-end server. As a result, the back-end server can learn a model by using the teacher data.

### 4. Effects

As described above, the information processing apparatus 10 selects a model to be used for generating a response on the basis of one of conditions input from the user U01 among from a plurality of models for generating responses to questions. The models are for generating the responses corresponding to the conditions that are different from one another. The information processing apparatus 10 generates the response to a question from the user U01 by using the selected model. Thus, it is possible for the information processing apparatus 10 to improve estimation accuracy in a response to a question.

The information processing apparatus 10 selects a model for generating a response on the basis of an attribute of the user U01, as the one condition, among form the models for generating responses corresponding to attributes that are different from one another. For example, the information processing apparatus 10 selects a model for generating a response corresponding to an attribute that is the same as that of the user U01. Thus, the information processing apparatus 10 can output a response (optimized for the user U01) that can satisfy the user U01.

The information processing apparatus 10 selects a model for generating a response corresponding to an attribute that is different from that of the user U01. For example, when receiving a question related to the other user U02 from the user U01, the information processing apparatus 10 selects a model to be used for generating a response on the basis of an attribute of the other user U02, as a condition, among form the models for generating the responses corresponding to the attributes that are different from one another. For example, the information processing apparatus 10 selects a model optimized for the attribute of the user U02. Thus, it is possible for the information processing apparatus 10 to improve estimation accuracy in a response to a question related to human relation.

The information processing apparatus 10 selects as the model, among from a plurality of models for outputting the responses and reliabilities of the responses, a model for generating a response to the question from the user U01 on the basis of values of the reliabilities output from the models in response to the question. Thus, it is possible for the information processing apparatus 10 to generate a response by using a model having a high probability of outputting a correct answer.

The information processing apparatus 10 selects a model to be used for generating a response on the basis of an area where the user U01 exists, as the one condition, among from models for generating responses corresponding to areas that are different from one another. Thus, it is possible for the information processing apparatus 10 to generate a response in consideration of an area of the user U01.

The information processing apparatus 10 selects a model for generating a response corresponding to the one condition selected by the user U01 among from the models. Thus, it is possible for the information processing apparatus 10 to improve estimation accuracy in a response to a question.

The information processing apparatus 10 selects two or more models among from a plurality of models. For example, the information processing apparatus 10 selects the two or more models among from a plurality of models for outputting the responses and reliabilities of the responses, generates responses and reliabilities of the responses in response to the question from the user U01 by using the selected two or more models, and outputs a response having a largest reliability value of the generated responses. Moreover, for example, the information processing apparatus 10 computes an average value of the reliabilities for each of contents of the generated responses, and outputs a response whose content has a largest computed average value. Thus, it is possible for the information processing apparatus 10 to more improve estimation accuracy in a response to a question.

The information processing apparatus 10 receives an evaluation for the response from the user U01. The response is generated by the generation unit. The information processing apparatus 10 learns the model by using the question from the user U01, the response generated in response to the question, and the evaluation for the response. For example, the information processing apparatus 10 selects a model, as the model, to be used for generating the response among from models, each of which outputs one of a predetermined response and a response having a content reverse to that of the predetermined response in response to the question from the user U01. The information processing apparatus 10 causes, when the evaluation for the response includes a positive evaluation, the model to learn the question from the user U01 and the response generate in response to the question, and causes, when the evaluation for the response includes a negative evaluation, the model to learn the question from the user U01 and the response having a content reverse to that of the response generated in response to the question. Thus, the information processing apparatus 10 can use the output response as teacher data regardless of whether or not a content of the output response is appropriate, and thus, as a result of increasing the number of teacher data, it is possible to improve estimation accuracy in a response.

The information processing apparatus 10 learns a model for generating a response corresponding to the one condition input by the user U01 by using the question from the user U01, the response generated in response to the question, and the evaluation for the response. Thus, it is possible for the information processing apparatus 10 to learn a plurality of models that are for generating responses in response to questions and for generating the responses corresponding to conditions different from one another.

The information processing apparatus 10 learns, by using (i) a question related to the other user U02 which is the question from the user U01, (ii) a response in response to the question, and (iii) an evaluation for the response, a model for generating a response corresponding to an attribute of the other user U02. Thus, it is possible for the information processing apparatus 10 to improve response accuracy in a question related to human relation.

The above “section, module, or unit” may be replaced by “means”, “circuit”, or the like. For example, a selection unit may be replaced by a selection means or a selection circuit.

According to one aspect of the embodiment, it is possible to improve accuracy in a response to a question sentence.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A generation apparatus comprising:
a selection unit that selects a model to be used for generating a response based on one of conditions input from a user among from a plurality of models for generating responses to inquiries, the models being for generating the responses corresponding to the conditions that are different from one another; and
a generation unit that generates the response to an inquiry from the user by using the model selected by the selection unit.

2. The generation apparatus according to claim 1, wherein the selection unit selects a model for generating a response based on an attribute of the user, as the one condition, among form the models for generating responses corresponding to attributes that are different from one another.

3. The generation apparatus according to claim 2, wherein the selection unit selects a model for generating a response corresponding to an attribute that is a same as that of the user.

4. The generation apparatus according to claim 2, wherein the selection unit selects a model for generating a response corresponding to an attribute that is different from that of the user.

5. The generation apparatus according to claim 1, wherein, when receiving from the user an inquiry related to another user, the selection unit selects a model for generating a response based on an attribute of the other user, as the one condition, among from the models for generating responses corresponding to attributes that are different from one another.

6. The generation apparatus according to claim 1, wherein the selection unit selects as the model, among from a plurality of models for outputting the responses and reliabilities of the responses, a model for generating a response to the inquiry from the user based on values of the reliabilities output from the models in response to the inquiry.

7. The generation apparatus according to claim 1, wherein the selection unit selects a model to be used for generating a response based on an area where the user exists, as the one condition, among from models for generating responses corresponding to areas that are different from one another.

8. The generation apparatus according to claim 1, the selection unit selects a model for generating a response corresponding to the one condition selected by the user among from the models.

9. The generation apparatus according to claim 1, the selection unit selects two or more models among from the models.

10. The generation apparatus according to claim 9, wherein
the selection unit selects two or more models among from a plurality of models, as the two or more models, for outputting the responses and reliabilities of the responses, and
the generation unit generates responses and reliabilities of the responses in response to the inquiry from the user by using the two or more models selected by the selection unit, and outputs a response having a largest reliability value of the generated responses.

11. The generation apparatus according to claim 9, wherein the generation unit generates responses and reliabilities of the responses to the inquiry from the user by using the two or more models selected by the selection unit, computes an average value of the reliabilities for each of contents of the generated responses, and outputs a response whose content has a largest computed average value.

12. The generation apparatus according to claim 1, further comprising:
a reception unit that receives an evaluation for the response from the user, the response being generated by the generation unit; and
a learning unit that learns the model by using the inquiry from the user, the response generated in response to the inquiry, and the evaluation for the response.

13. The generation apparatus according to claim 12, wherein the learning unit causes, when the evaluation for the response includes a positive evaluation, the model to learn the inquiry from the user and the response generated in response to the inquiry, and causes, when the evaluation for the response includes a negative evaluation, the model to learn the inquiry from the user and the response having a content reverse to that of the response generated in response to the inquiry.

14. The generation apparatus according to claim 12, wherein the learning unit learns a model for generating a response corresponding to the one condition input by the user by using the inquiry from the user, the response generated in response to the inquiry, and the evaluation for the response.

15. The generation apparatus according to claim 12, the learning unit learns, by using (i) an inquiry related to another user which is the inquiry from the user, (ii) a response in response to the inquiry, and (iii) an evaluation for the response, a model for generating a response corresponding to an attribute of the other user.

16. The generation apparatus according to claim 1, wherein the selection unit selects a model, as the model, to be used for generating the response among from models, each of which outputs one of a predetermined response and a response having a content reverse to that of the predetermined response in response to the inquiry from the user.

17. A generation method comprising:
selecting a model to be used for generating a response based on one of conditions input from a user among from a plurality of models for generating responses to inquiries, the models being for generating the responses corresponding to the conditions that are different from one another; and
generating the response to an inquiry from the user by using the model selected in the selecting.

18. A non-transitory computer-readable recording medium having stored a generation program that causes a computer to execute a process comprising:
selecting a model to be used for generating a response based on one of conditions input from a user among from a plurality of models for generating responses to inquiries, the models being for generating the responses corresponding to the conditions that are different from one another; and
generating the response to an inquiry from the user by using the model selected in the selecting.
